(19) United States
(12) Patent Application Publication
(10) Pub. No.: US 2007/0133767 A1
(43) Pub. Date: Jun. 14, 2007

(54) Apparatus, system, method and computer program product for pre-paid long distance telecommunications

(75) Inventors: Bruce Hahn, Roswell, GA (US); Adam Somer, Atlanta, GA (US)

Correspondence Address: VENABLE LLP, P.O. BOX 34385, WASHINGTON, DC, 20043-9998, US

(73) Assignee: American Telecom Services, Inc., City of Industry, CA (US)

(21) Appl. No.: 11/636,087

(22) Filed: Dec. 7, 2006

Related U.S. Application Data
(60) Provisional application No. 60/748,584, filed on Dec. 9, 2005.

(51) Int. Cl. H04M 15/00

(52) U.S. Cl. 379/114.2

(57) ABSTRACT

An apparatus system, method and computer program product for providing pre-paid telecommunications services is set forth and may include: receiving an automatic number identification (ANI) at an ANI recognition system of a service provider platform from a user, where the user having previously acquired a communications device, where a pre-paid service has been bundled with the device, and where, upon the user having depressed a long distance service (LDS) auto-key having been pre-programmed with a feature code and dialing sequence may include exposing the ANI. In another exemplary embodiment, the method may further include: upon an initial use of the communications device by the user, upon the user having depressed the LDS auto-key, receiving at the service provider platform at least one of: retailer identification; an account number; and/or the automatic number identification (ANI) of the user. In another exemplary embodiment, the feature code and dialing sequence of the communications device may include suppressing dial tone and ring back.

### CROSS REFERENCE TO RELATED APPLICATIONS

The present invention is a Non-provisional U.S. Application claiming the benefit of U.S. Provisional Patent Application 60/748,584 (Attorney Docket No. 63870-224742) entitled “APPARATUS, SYSTEM, METHOD AND COMPUTER PROGRAM PRODUCT FOR PRE-PAID LONG DISTANCE TELECOMMUNICATIONS”, to HAHN et al., of common assignee to the present invention, the contents of which are incorporated herein by reference in their entirety.

### BACKGROUND OF THE INVENTION

1. Field of the Invention

The present invention relates generally to telecommunications hardware and services and, more particularly, to delivery of long distance telecommunications services.

2. Related Art

Pre-paid telephone service has conventionally been available using a pre-paid phone card. Use of a pre-paid phone card is increasingly popular because of cost savings compared to standard long distance service. Prepaid calling cards often offer much lower domestic and international long distance rates than the regular long distance service from major phone companies. In some cases, a monthly fee, taxes and other fees may account for 10% or more of total long distance bill. Using pre-paid calling cards may lead to savigs of up to 60-70% on a long distance phone bill in the United States.

Prepaid calling cards may enable a user to enjoy low long distance rates no matter where user is located. A user may call from home, office, pay phone, cell phone and hotel, airport, etc. If a user's phone bill is out of control, prepaid calling cards can help bring phone expenses within budget. Prepaid phone cards may be provided as gifts for friends and/or family.

Some phone cards allow a user to call the USA from certain foreign countries—with a prepaid calling card a user may avoid overseas calling issues. Prepaid calling cards may provide low long distance rates and help a user avoid expensive roaming charges if using a cell phone.

A conventional pre-paid calling service may assign a user a personal calling card number (e.g., a personal identification number (PIN), or an authorization code). A PIN or authorization code may include, e.g., a seven to fourteen (7-14) digit exclusive number. The PIN is uniquely assigned to a single user. When the pre-paid calling service is purchased by a user, the PIN (and instructions) are provided to the user. In the case of an online purchase, the PIN and instructions might be e-mailed to the user. In the case of pre-paid phone cards, a PIN may usually be located on the back of a calling card and may be covered with a silver strip.

A conventional phone call may be made using a pre-paid calling service from any touch-tone telephone according to the following steps:

1. a user may dial a 1-800-access number (keying approximately 11 digits on the touchtone phone) or a local access number that may appear on the back of the user's card.

2. the user may follow interactive voice instructions presented, which may be presented to the user by a voice response unit (VRU), and the user may be prompted to enter the user's PIN number (entering the PIN may require keying an additional approximately 7-14 digits on the touchtone phone). In some cases, the card may be preprogrammed with the service provider automatic number identification (ANI).

3. the user then follows further interactive instructions to dial a telephone number, as the user would normally call:
a. for international calls 011+Country Code+City+Local Number (potentially keying another approximately 11 or more digits on the touchtone phone).
b. for domestic calls 1+Area Code+Local Number (potentially keying another approximately 11 digits on the touchtone phone).

4. to make another call, the user might be required to press the pound key twice (##), or an asterisk (*) key, or a similar functioning key sequence, and then would follow instructions in step 3.

Conventional use of a phone card may incur extra charges. Such charges may include, e.g., but are not limited to, charges set by specific terms and conditions of the sale. Some cards may incur charges from a pay phone, a cell phone, or a hotel phone over which the phone card company has no control. Most all phone cards may have a combination of one or more of the following charges:

Time increment charges—The time increment charges are for the actual time a user spends on-line in a time increment. The time increments may vary from 1 second to 5 minutes.

Connection fee charges—A one-time charge may be charged for initiating a single call. Each and every time the card is used by placing a call by the user and a called party answers, the user may be charged a connection fee which may be deducted from the available minutes. Cards with a connection fee may be better for long duration calling.

Initial connection/weekly/monthly service/maintenance fees—Some cards may have an initial set up fee. Some, may charge a weekly or monthly fee, which may be charged after the first time the card is used and may deduct in minutes or dollars from the card value. Even if the user is not using a calling card charges may accumulate.

Pay phone/cellular phone charges—Nearly all phone card calls originating from a Pay Phone may be charged a fee per call. This fee is in certain cases required by federal law and the fee may typically range from 35 to 90 cents per call. This amount may be deducted from the card value. If a user's cellular or mobile phone company allows the user to call from a mobile phone, there maybe a charge per call fee. Some mobile telephone contracts do not allow the use of alternate carriers like phonecards or dial around services.

Taxes—There may be Federal Communications Commission (FCC), federal, state and/or local charges, i.e., taxes based on where a call originates. (These charges may be the same taxes that appear on a telephone phone bill each month and may be calculated on each call.) Normally these taxes may be factored into the rate but they can be deducted separately from the value of the card.

Unfortunately, conventional pre-paid telephone service offerings, as noted above, have required users to enter many more digits to take advantage of the services. The inconvenience associated with entering so many digits to place a call have made the services less successful than one would expect from a service providing such potential cost savings.

FIG. 1, described further below, depicts an exemplary communications network environment 100. The concept of long distance companies in the United States was created by the breakup of AT&T into a long distance company and several local regional Bell Operating Companies (RBOCs). Telecommunications legislation and regulatory actions in the past few decades in the United States has led to creation of a large number of incumbent local exchange carriers (ILECs), intra exchange carriers (IXCs), and competitive local exchange carriers (CLECs). Through a complex system of regulation, telephone calls are placed through these multi-vendor networks using the vast networks of cooperating companies. In 1984, AT&T was broken up by antitrust regulators in the U.S., forming a network of local phone companies (the ILECs), and long distance companies (the interexchange carriers (IXCs)). Following the breakup, initially each local loop was monopolized and run by a local exchange carrier (LEC), typically a Regional Bell Operating Company (RBOC) or an independent telephone company such as GTE, etc., including end office (EO) switches 104, 108. Excluding cellular phones, the local loop was a required input in the production of long distance services, and typically long distance companies did not have their own comparable local loop. In telecommunications, the use of a local exchange incurred charges to originate calls (access origination) from an originating caller 102 or to terminate calls (access termination) from a terminating caller 110. Placing calls terminated beyond the RBOC of the originated call, requires using a network 106 of an IXC, or long distance phone company, accessed at a point of presence (POP) 132, 134, to carry the call. IXCs did not have the benefit of a local regional monopoly of local loops to provide continual revenue. Indeed, competition for long distance service became very brisk with companies like MCI, AT&T, and Sprint, competing for long distance services. Calls are set up using a signaling network 114. Traffic could also be switched at a business using a private branch exchange (PBX) 112.

Passage of the Telecommunications Act of 1996, authorizing competition in the local phone service market, permitted CLECs (see FIG. 2, 104c, for example) to compete with ILECs in providing local exchange services. This competition created even more companies which compete for long distance service. FIG. 3 depicts an exemplary voice over Internet Protocol (VOIP) network environment 286 using gateways 288 to transport voice traffic over a data network 140.

In this nvironment, long distance companies have found an alternative revenue source by selling pre-paid long distance to third parties which would market access to telecommunications services, i.e. thus pre-paid long distance services have been created. However, the requirement that consumer users enter a lengthy series of digits just to place a call, has prevented these pre-paid services from being adopted more widespread.

When a customer places a telephone call, the call may often originate onto an ILEC switch 104, then by entering the series of digits of the PIN, and then the telephone number, may be transported over a network of the ILEC, and/or an IXC's network 106, and then may be terminated on potentially another ILECs' facilities 108. What is needed then is an improved way to originate a call using pre-paid long distance services which overcomes the shortcomings of conventional methods.

### SUMMARY OF THE INVENTION

The present invention sets forth various exemplary embodiments of apparatuses, systems, methods and computer program products for providing pre-paid telecommunications services.

In an exemplary embodiment, a method may include: receiving an automatic number identification (ANI) at an ANI recognition system of a service provider platform from a user, where the user having previously acquired a communications device, where a pre-paid service has been bundled with the device, and where, upon the user having depressed a long distance service (LDS) auto-key having been pre-programmed with a feature code and dialing sequence may include exposing the ANI.

In another exemplary embodiment, the method may further include: upon an initial use of the communications device by the user, upon the user having depressed the LDS auto-key, receiving at the service provider platform at least one of: retailer identification; an account number; and/or the automatic number identification (ANI) of the user.

In yet another exemplary embodiment, the retailer identification may be used for revenue sharing between the service provider and a retailer.

In an exemplary embodiment, a method may include: allowing the user to use a value associated with the user.

In an exemplary embodiment, the value may include, e.g., but not be limited to, a value of prepaid long distance, a value of communications services,a value of minutes of services, a monetary value, an account value, a checking account value, a savings account value, a money market account value, a credit value, a debit value, and/or a quantity of products and/or services value.

In an exemplary embodiment, use of the value may include, e.g., but not limited to, placing a telecommunications call, purchasing a product and/or service, accessing a service, sending money, purchasing a product and/or service appearing online, purchasing a product and/or service appearing on a broadcast, purchasing a product and/or appearing on programming, purchasing a product and/or service appearing on broadcast programming, purchasing a product and/or service appearing on a direct response television (DRTV) broadcast television, and/or purchasing a product and/or service appearing on a Home Shopping Network (HSN) and/or QVC broadcast programming. In an exemplary embodiment, a DRTV program may include, e.g., but not limited to, an infomercial, a Home Shopping Network (HSN)® broadcast, and/or or QVC® broadcast. In an exemplary embodiment, a button may be provided on the phone to indicate user authorization of use of value. In an exemplary embodiment, the value may be stored in a database, in a record which may be associated with the unique communications device. According to an exemplary embodiment, a button may be dedicated to activating such functionality on a telephony device.

In another exemplary embodiment, the method may include: pre-provisioning an account associated with the communications device of the user a promotional amount of the value.

In an exemplary embodiment, a method may include: prompting the user to replenish the value.

In an exemplary embodiment, a method may include: prompting the user to authorize use of the value. According to an exemplary embodiment, user authorization may include, e.g., but not limited to, a validation; entry of a password; entry of a personal identification number (PIN); a biometric; a reverse Turing test; and/or a digital signature, etc.

In an exemplary embodiment, a method may include: allowing the user to place a telecommunications call using a value of calling minutes until depletion.

In another exemplary embodiment, the method may include: pre-provisioning an account associated with the communications device of the user a promotional amount of the value of the calling minutes.

In an exemplary embodiment, a method may include: prompting the user to replenish the value upon the value reaching a pre-determined threshold.

In one exemplary embodiment, the method may include where the prompting may include prompting via an interactive voice response (IVR) type system.

In another exemplary embodiment, the method may further include: receiving from the user an agreement to automatically replenish the account of the user upon occurrence of at least one criterion.

In an exemplary embodiment of the method, the criterion may include a value of the account reaching an automatic replenishment threshhold level.

In an exemplary embodiment of the method the automatic replenishment threshold level is user selectable.

In an exemplary embodiment, the automatic replenishment may include debiting a financial account of the user may include at least one of: a monetary account; a savings account; a debit card account; a checking account; a money market account; and/or a credit card account.

In an exemplary embodiment, the feature code and dialing sequence of the communications device may include suppressing dial tone and ring back.

In another exemplary embodiment, a machine-readable medium that provides instructions, which when executed by a computing platform, cause the computing platform to perform operations may include a method, which may include: receiving an automatic number identification (ANI) at an ANI recognition system of a service provider platform from a user, where the user having previously acquired a communications device, where a pre-paid service has been bundled with the device, and where, upon the user having depressed a long distance service (LDS) auto-key having been pre-programmed with a feature code and dialing sequence may include exposing the ANI.

In another exemplary embodiment of the machine readable medium, the method may further include:upon an initial use of the communications device by the user, upon the user having depressed the LDS auto-key, receiving at the service provider platform at least one of: retailer identification; an account number; and/or the automatic number identification (ANI) of the user.

In another exemplary embodiment of the machine readable medium, the retailer identification may be used for revenue sharing between the service provider and a retailer.

In another exemplary embodiment of the machine readable medium, the method may further include: allowing the user to place a telecommunications call using a value of calling minutes until depletion.

In another exemplary embodiment of the machine readable medium, the method may further include: pre-provisioning an account associated with the phone device of the user a promotional amount of the value of the calling minutes.

In another exemplary embodiment of the machine readable medium, the method may further include: prompting the user to replenish the value upon the value reaching a pre-determined threshold.

In another exemplary embodiment of the machine readable medium, the prompting of the method may include prompting via an interactive voice response (IVR) type system.

In another exemplary embodiment of the machine readable medium, the method may further include: receiving from the user an agreement to automatically replenish the account of the user upon occurrence of at least one criterion.

In another exemplary embodiment of the machine readable medium, where the criterion may include a value of the account reaching an automatic replenishment threshold level.

In another exemplary embodiment of the machine readable medium, the automatic replenishment threshold level of the method is user selectable.

In another exemplary embodiment of the machine readable medium, the automatic replenishment of the method may include debiting a financial account of the user may include at least one of: a savings account; a debit card account; a checking account; and/or a credit card account.

In another exemplary embodiment of the machine readable medium, the feature code and dialing sequence of the communications device may include: suppressing dial tone and ring back.

In another exemplary embodiment of the invention, a telecommunications apparatus may include: a communications device, which may include: a long distance service (LDS) auto-key adapted to, upon user depression, to suppress dial tone and ring back, and to expose an automatic number identification (ANI) to an ANI recognition system of a prepaid service provider platform.

In another exemplary embodiment of the telecommunications apparatus, the communications device may include at least one of: a corded telephone; a cordless telephone; a digital spread spectrum (DSS) cordless telephone; a 2.4 GHz DSS cordless telephone; a wired telephone; a wireless telephone; a mobile telephone; a personal digital assistant (PDA); a computing device; a single unit device; a multi-unit device; a multi-handset device; a cellular telephone device; a telephony device; a base station device; and/or an extension base device.

In another exemplary embodiment of the telecommunications apparatus, the telecommunications apparatus may further include: a base station adapted to receive the communications device; and at least a first extension base in wireless communication with the base station, adapted to receive a second of the communications devices.

In another exemplary embodiment of the telecommunications apparatus, the telecommunications apparatus may further include: at least a second extension base in wireless communication with the base station, adapted to receive a third of the communications devices.

### BRIEF DESCRIPTION OF THE FIGURES

Various exemplary features and advantages of the invention will be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears.

FIG. 1 is an exemplary embodiment of a block diagram providing an overview of an exemplary telecommunications network providing exemplary local exchange carrier (LECs) services within one or more local access and transport areas (LATAs);

FIG. 2 is an exemplary embodiment of a block diagram illustrating an exemplary overview of a telecommunications network providing both local exchange carrier (LEC) and interexchange carrier (IXC) services between subscribers located in different local access and transport areas (LATAs);

FIG. 3 illustrates an exemplary embodiment of a block diagram of an exemplary voice over data network providing what may be an exemplary competitive local exchange carrier (CLEC) service between subscribers;

FIG. 4 depicts an exemplary embodiment of a block diagram of pre-paid telecommunications service long distance service (LDS) device including an exemplary auto-key device according to an exemplary embodiment of the present invention;

FIG. 5 depicts an exemplary embodiment of a computer system that may be used in computing devices such as, e.g., client and/or server devices according to an exemplary embodiment of the present invention;

FIG. 6 depicts an exemplary embodiment of a flow diagram which may be used to activate the pre-paid telecommunications device of FIG. 4;

FIG. 7 depicts an exemplary embodiment of a digital 2.4 GHz DSS cordless master and extension combination package including the LDS auto-key feature according to an exemplary embodiment of the present invention;

FIG. 8 depicts another exemplary embodiment of a digital 2.4 GHz DSS cordless master base station and single extension wireless handset combination package including the LDS auto-key feature according to an exemplary embodiment of the present invention;

FIG. 9 depicts another exemplary embodiment of a digital 2.4 GHz DSS cordless master base station and two wireless handset extensions combination package including the LDS auto-key feature according to an exemplary embodiment of the present invention;

FIG. 10 depicts another exemplary embodiment of a digital 2.4 GHz DSS cordless master base station and three wireless handset extensions combination package including the LDS auto-key feature according to an exemplary embodiment of the present invention; and

FIG. 11 depicts an exemplary point of sale marketing display case marketing the telecommunications service offering according to an exemplary embodiment of the present invention.

### DETAILED DESCRIPTION OF VARIOUS EXEMPLARY EMBODIMENTS OF THE INVENTION

A preferred exemplary embodiment of the invention is discussed in detail below. While specific exemplary embodiments are discussed, it should be understood that this is done for illustration purposes only. A person skilled in the relevant art will recognize that other components and configurations may be used without parting from the spirit and scope of the invention.

### Overview of the Invention

An exemplary embodiment of the present invention represents an apparatus, system, method, and/or computer accessible medium adapted to enable a more user-convenient method to access pre-paid telecommunications services.

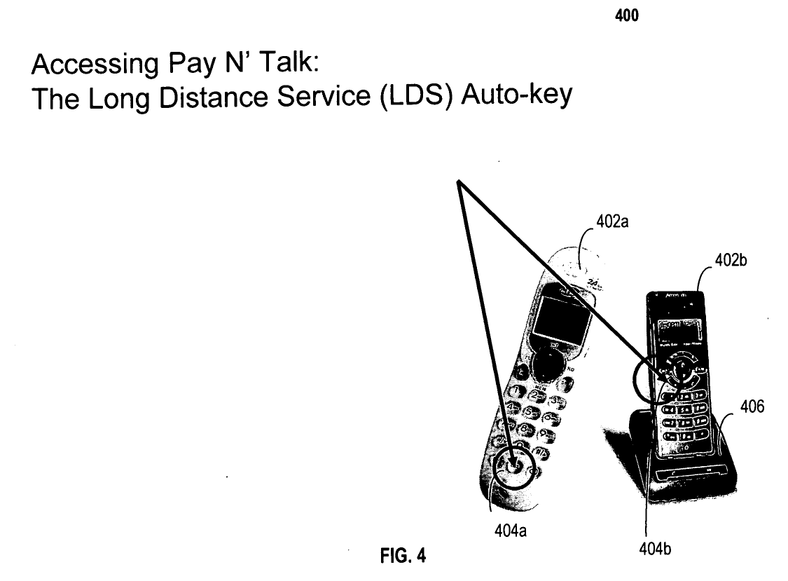

The pre-paid telecommunications services system according to the present invention is available from American Telecom Services, Inc., a DL Corporation, of 2466 Peck Road, City of Industry, Calif. 90601 USA. According to an exemplary embodiment of the present invention, the pre-paid telecommunications services system, as shown in FIG. 4, below, may allow the user to access pre-paid telecommunications services with a fraction of the normal number of digits needing to be manually keyed.

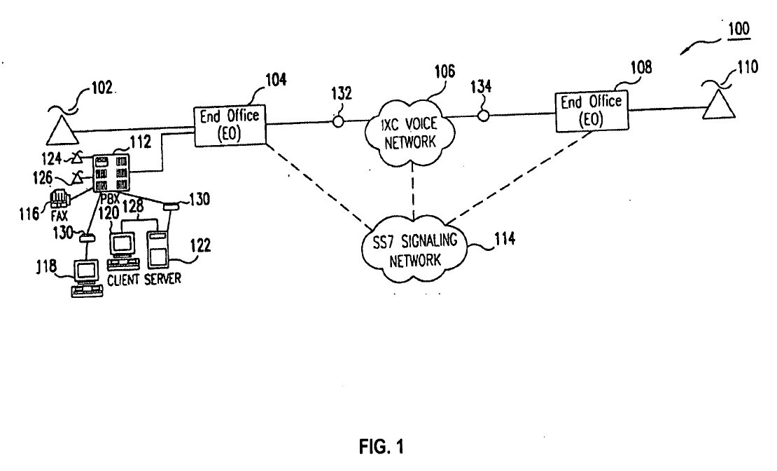

FIG. 1 is an exemplary embodiment of a block diagram providing an overview of an exemplary telecommunications network 100 providing exemplary local exchange carrier (LECs) services within one or more local access and transport areas (LATAs). FIG. 1 is described further below.

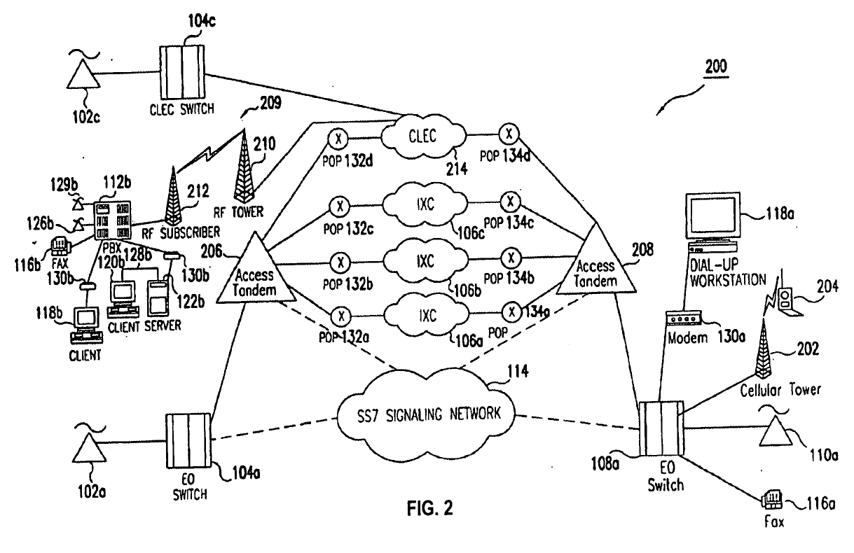

FIG. 2 is an exemplary embodiment of a block diagram illustrating an exemplary overview of a telecommunications network 200 providing both local exchange carrier (LEC) and a plurality of interexchange carrier (IXC) services between subscribers located in different local access and transport areas (LATAs). FIG. 2 is also further described below.

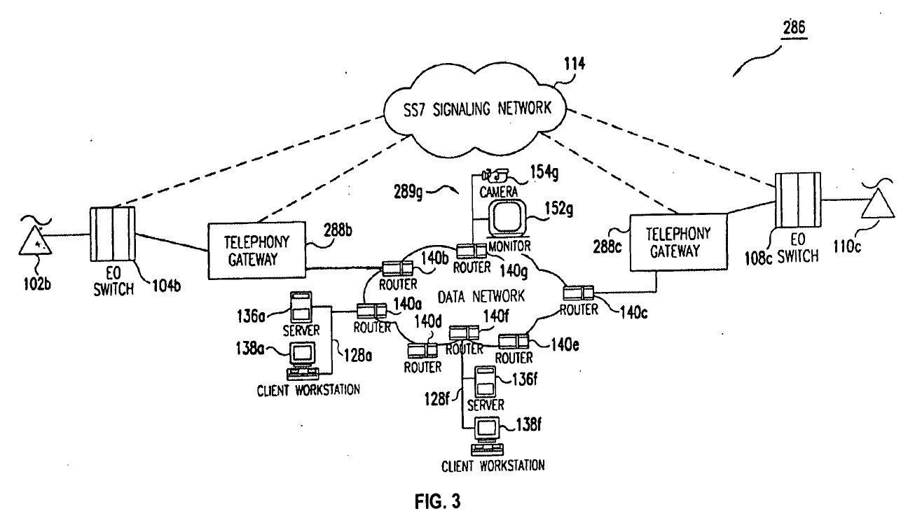

FIG. 3 illustrates an exemplary embodiment of a block diagram of an exemplary voice over data network 286 providing an exemplary competitive local exchange carrier (CLEC) service between subscribers. FIG. 3 is also further described below.

FIG. 4 depicts an exemplary embodiment of a block diagram 400 of a pre-paid telecommunications service long distance service (LDS) device 402 including an exemplary auto-key 404 according to an exemplary embodiment of the present invention.

As shown in diagram 400, the device may include one or more telephony devices 402. In one exemplary embodiment, a wireless telephony device 402a is shown which may include an LDS auto-key button 404a. In another exemplary embodiment, a wireless telephony device 402b is shown which may include a docking base 406 to which the device 402b may communicate, and may further include an LDS auto-key button 404b. According to an exemplary embodiment, the LDS auto-key may give a user of the device 402 (a,b) a one-touch, seamless, instantaneous access to pre-paid long distance telecommunications service. The auto-key may be pre-programmed prior to customer delivery, to execute feature codes to notify the switch of the originating end of the call to display authenticating information to the pre-paid service provider switch, such as, e.g., but not limited to, in the United States, a feature code sequence *82 pause and the access phone number (if a user has blocked display of ANI, such as blocking callerid information, then this feature code key sequence would reveal it), and to access the pre-paid long distance carrier, thus the present invention may advantageously avoid potentially dozens of conventional key/button strokes by the user.

According to an exemplary embodiment, a button may be provided on the telephony device, which when activated, may allow a user to access or use, value stored in a database, associated with the user.

According to an exemplary embodiment, the value may include, e.g., but not limited to, a value of prepaid long distance, a value of communications services, a value of minutes of services, a monetary value, an account value, a checking account value, a savings account value, a money market account value, a credit value, a debit value, and/or a quantity of products and/or services value.

In an exemplary embodiment, use of the value may include, e.g., but not limited to, placing a telecommunications call, purchasing a product and/or service, accessing a service, sending money, purchasing a product and/or service appearing online, purchasing a product and/or service appearing on a broadcast, purchasing a product and/or appearing on programming, purchasing a product and/or service appearing on broadcast programming, purchasing a product and/or service appearing on a direct response television (DRTV) broadcast television, and/or purchasing a product and/or service appearing on a Home Shopping Network (HSN) and/or QVC broadcast programming. According to an exemplary embodiment, a button may be dedicated to activating such functionality on a telephony device.

In an exemplary embodiment, the system, method or computer program product may include: pre-provisioning an account associated with the communications device of the user a promotional amount of the value.

In an exemplary embodiment, a method may include: prompting the user to replenish the value.

In an exemplary embodiment, a method may include: prompting the user to authorize use of the value. According to an exemplary embodiment, user authorization may include, e.g., but not limited to, a validation; entry of a password; entry of a personal identification number (PIN); a biometric; a reverse Turing test; and/or a digital signature, etc.

According to an exemplary embodiment, the prepaid value button may be used to transmit pre-paid cash. Advantageously, this function may serve the unbanked consumer. Rather than a consumer needing to go to a check cashing service, a prepaid Mastercard-like function may be provided on the communications device. A percentage fee may be paid to the communications equipment company, and a percentage may be paid to the retailer, in one exemplary embodiment.

According to another exemplary embodiment, during live shopping, when a consumer user is viewing programming, such as, e.g., but not limited to, QVC, or HSN, the user may press a button on the communications device, and they can using a prepaid QVC Mastercard, associated with the user, place a transaction, making a purchase, for example, without needing to provide their credit card number over the telephone. Much like an EasyPass, after a user has set up the account, from then on, the user may use the telephony button to transact a purchase, according to an exemplary embodiment. This offering may be targeted to the homebound and senior citizens who are wary of making purchases over the Internet, according to an exemplary embodiment.

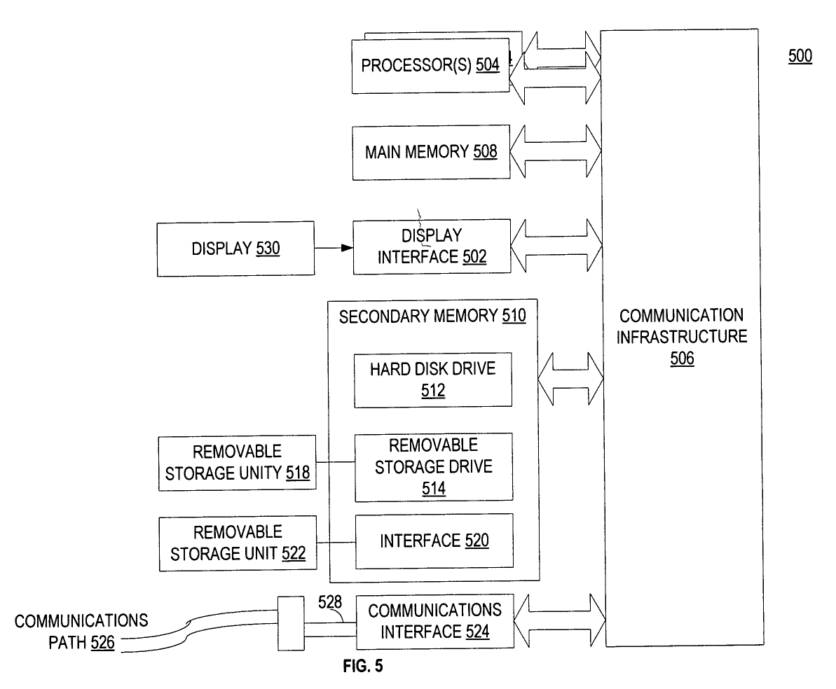

FIG. 5 is an exemplary computing device 500, and is described further below and may be included in any of the exemplary devices according to the present invention.

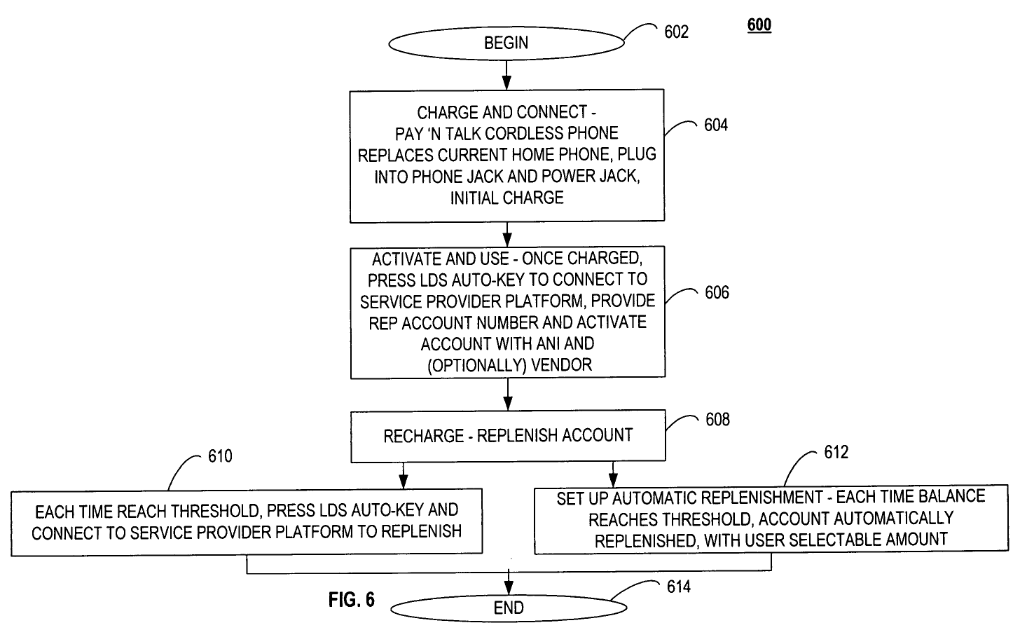

FIG. 6 depicts an exemplary embodiment of a flow diagram 600 which may be used to activate the pre-paid telecommunications device of FIG. 4.

According to an exemplary embodiment, diagram 600 may begin with 602 and may continue immediately with 604.

In 604, according to an exemplary embodiment, a device may be coupled to a phone jack and power jack to charge the device and to couple the device to the local loop. From 604, diagram 600 may continue immediately with 606.

In 606, according to an exemplary embodiment, once the phone device 402 is charged, the device 402 may be ready for use and may received a depression of the LDS auto-key. Upon receipt of user selection of the LDS auto-key, the device 402 may instantly, and seamlessly connect the device to a long distance telecommunications service provider (which in an exemplary embodiment may be an IXC) representative within milliseconds, by performing the necessary pre-programmed signaling (which may have been pre-programmed in software, hardware, and/or firmware) to set up a call to the service provider. The service provider may, in an exemplary embodiment, take the account number included in the packaging accompanying the device 402, and may activate the account. To make the first long distance call, the consumer may then simply press the LDS auto-key 404 and dial the desired number using the same dialing format as conventionally used, i.e., merely entering 1-(area code) (3 digit exchange)—(4 digit extension), or the like, depending on the region in which the user resides. From 606, diagram 600 may continue immediately with 608.

In 608, according to an exemplary embodiment, since the service is a pre-paid service, the account may need to be replenished and/or recharged after use. Each time a user makes a call as described above with reference to 606, the cost of that call may be deducted from a pre-paid value associated with an account which in turn is associated with device 402. The pre-paid value thus may be decreased following each call and the decreased pre-paid value may be stored in a database of the service provider. According to various exemplary embodiments of the present invention, there may be, e.g., but not limited to, two ways to replenish and/or recharge a user's account. From 608, diagram 600 may continue with 610 for a first way to replenish and/or recharge, and/or may continue with 612 for a second way to replenish and/or recharge.

In 610, according to an exemplary embodiment, each time the value of a customer user's account may hit a pre-determined threshold level, then the user may press the LDS auto-key to connect to the service provider to replenish/recharge the account. From 610, diagram 600 may continue with 606 (where the device 402 may be used as described with reference to 606 above) if the account has been replenished, or if the account has been depleted to a zero balance, then operation may be inhibited and diagram 600 may end with 614. According to one exemplary embodiment, the user may re-initiate service, following depletion, by supplementing the user's account balance by contacting the service provider.

In 612, according to another exemplary embodiment, a customer may alternatively agree to set up an automatic replenishment system with the service provider. Using the automatic replenishment, each time an account balance falls below a pre-set threshold limit, (which in an exemplary embodiment may be customer user selectable), the account may be automatically replenished with an amount (which may in an exemplary embodiment be user selectable, and may be preset to an amount which may be user definable). From 610, diagram 600 may continue with 606 (where the device 402 may be used as described with reference to 606 above) if the account has been replenished, or if the account has been depleted to a zero balance (due for example to expiration of a credit card being used for automatic replenishment), then operation may be inhibited and diagram 600 may end with 614. According to one exemplary embodiment, the user may re-initiate service, following depletion, by supplementing the user's account balance by contacting the service provider.

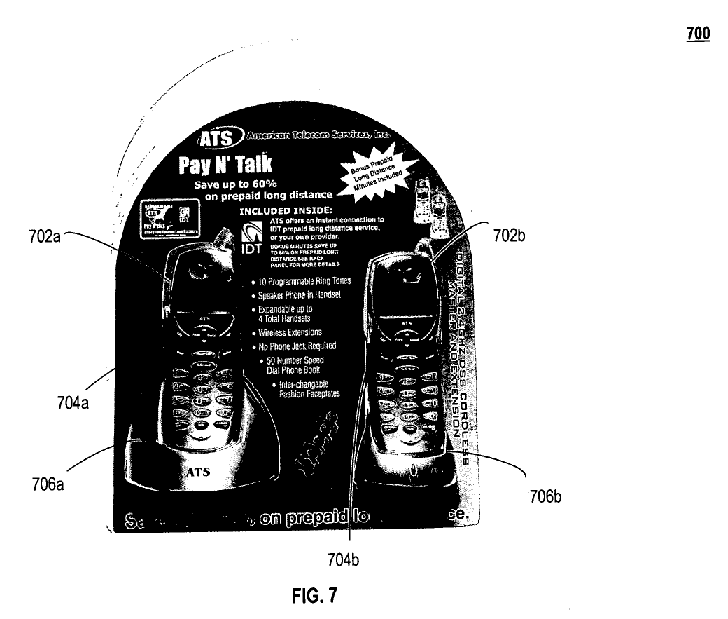

FIG. 7 depicts a diagram 700 of an exemplary embodiment of a telephone, such as, e.g., but not limited to, an exemplary cordless telephone device 702a master base station 706a and extension device 702b and base 706b combination package including LDS auto-key features 704a, b, respectively, according to an exemplary embodiment of the present invention. In an exemplary embodiment, the devices may communicate using digital spread spectrum 2.4 GHz frequency band communication between the master 706a and extension 706b bases. In another exemplary embodiment, the present invention may be incorporated into any other device including, e.g., but not limited to, a telephone, a mobile phone, a communications device, a wired line device, a wireless device, a personal digital assistant (PDA), a cellular phone (i.e., analog, digital, 1G, 2G, 3G, etc.), a cordless phone, and/or a multi-handset cordless phone, etc. A cellular phone could use the present invention to receive pre-paid international calling services according to one exemplary embodiment.

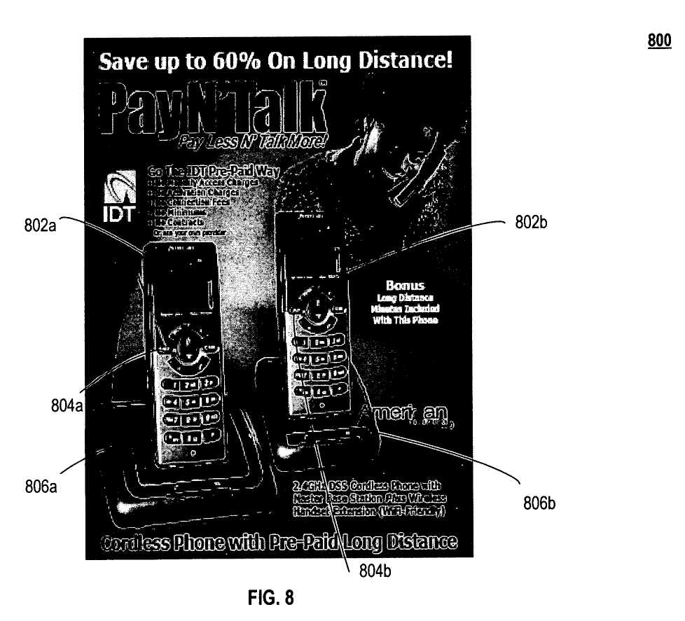

FIG. 8 depicts a diagram 800 of an exemplary embodiment of a telephone, such as, e.g., but not limited to, an exemplary cordless telephone device 802a master base station 806a and extension device 802b and base 806b combination package including LDS auto-key features 804a, b, respectively, according to an exemplary embodiment of the present invention. In an exemplary embodiment, the devices may communicate using digital spread spectrum 2.4 GHz frequency band communication between the master 806a and extension 806b bases. In another exemplary embodiment, the present invention may be incorporated into any other device including, e.g., but not limited to, a telephone, a mobile phone, a communications device, a wired line device, a wireless device, a personal digital assistant (PDA), a cellular phone (i.e., analog, digital 1G, 2G, 3G, 4G, nG, etc.), a cordless phone, and/or a multi-handset cordless phone, etc.

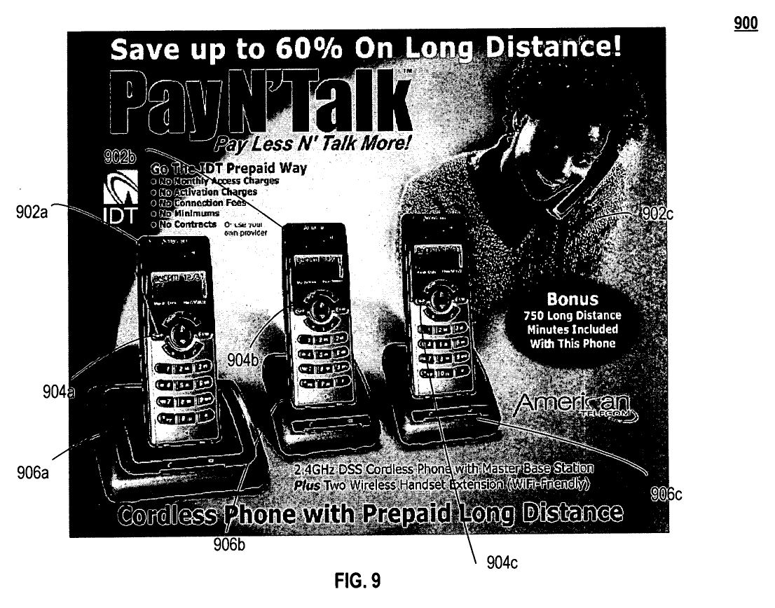

FIG. 9 depicts a diagram 900 of an exemplary embodiment of a telephone, such as, e.g., but not limited to, an exemplary cordless telephone device 902a master base station 906a and extension devices 902b, 902c and base 906b combination package including LDS auto-key features 904a, b, c, respectively, according to an exemplary embodiment of the present invention. In an exemplary embodiment, the devices may communicate using digital spread spectrum 2.4GHz frequency band communication between the master 906a and extension 906b, 906c bases. In another exemplary embodiment, the present invention may be incorporated into any other device including, e.g., but not limited to, a telephone, a mobile phone, a communications device, a wired line device, a wireless device, a personal digital assistant (PDA), a cellular phone (i.e., analog, digital, 1G, 2G, 3G, 4G, nG, etc.), a cordless phone, and/or a multi-handset cordless phone, etc.

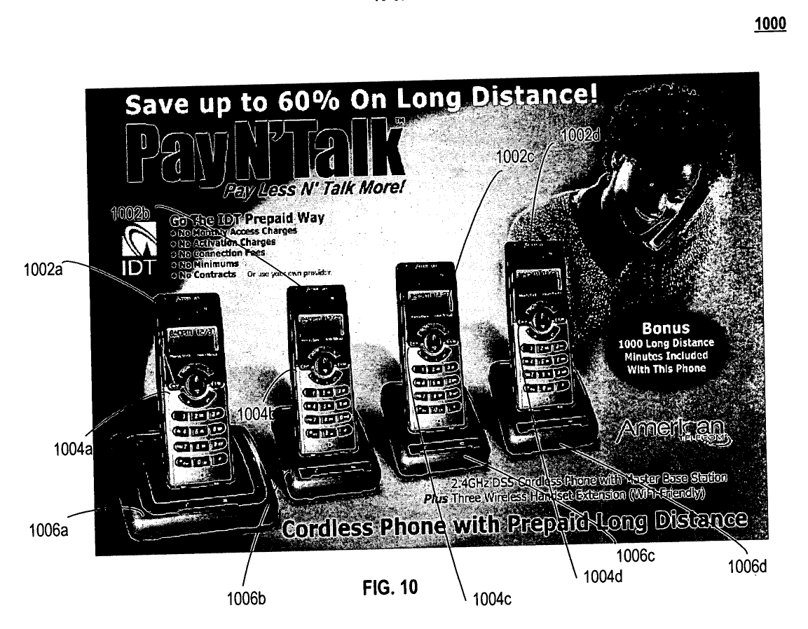

FIG. 10 depicts a diagram 1000 of an exemplary embodiment of a telephone, such as, e.g., but not limited to, an exemplary cordless telephone device 1002a master base station 1006a and extension devices 1002b, 1002c, 1006d and base 1006b combination package including LDS auto-key features 1004a, b, c, d, respectively, according to an exemplary embodiment of the present invention. In an exemplary embodiment, the devices may communicate using digital spread spectrum 2.4 GHz frequency band communication between the master 1006a and extension 1006b, 1006c, 1006d bases. In another exemplary embodiment, the present invention may be incorporated into any other device including, e.g., but not limited to, a telephone, a mobile phone, a communications device, a wired line device, a wireless device, a personal digital assistant (PDA), a cellular phone (i.e., analog, digital, 1G, 2G, 3G, 4G, nG, etc.), a cordless phone, and/or a multi-handset cordless phone, etc.

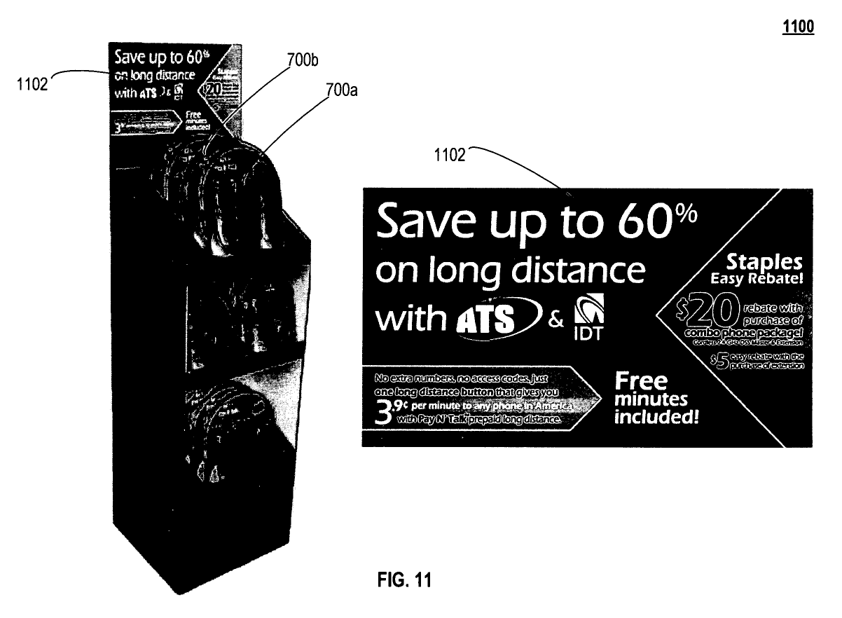

FIG. 11 depicts a diagram 1100 an exemplary point of sale marketing display case marketing the telecommunications service offering according to an exemplary embodiment of the present invention including marketing promotional material 1102.

Exemplary Functionality of an Exemplary Embodiment of the Present Invention

In an exemplary embodiment, devices 402 may be cordless devices available from American Telecom Services, Inc., a DL Corporation, of 2466 Peck Road, City of Industry, Calif. 90601 USA. The devices, in an exemplary embodiment, may be cordless phones 402 which may be used in homes and small businesses. In an exemplary embodiment, the phones 402 may come packaged with calling service accessible from an L.D.S (Long Distance Service) auto-key or button 404. In an exemplary embodiment, when the user presses the LDS button 404 the phone 402 may automatically dial the long distance service provider, which may be, in an exemplary embodiment, any communications services provider, such as, e.g., but not limited to, an IDT platform available from IDT Corporation of 520 Broad St., Newark, N.J. 07102 USA.

In an exemplary embodiment, when using the service provider platform for the first time, the user may be prompted for:
1) A store name/Vendor (supplied by End User);
2) A unique account number (11 digit number supplied by long distance service provider and printed and packaged by the company providing the phone device 402);
3) The phone number from which the call originates, i.e., the automatic number identification (ANI).

In an exemplary embodiment, once the initial information may have been captured, the user may be allowed to use a value of promotional minutes determined by the provider of the phone device 402 that may have been pre-provisioned on the account associated with the phone device 402. In an exemplary embodiment, the user may then be able to use the “LDS” button and/or calling card until promotional minute/value depletion.

In an exemplary embodiment, the user may be prompted via a standard interactive voice response (IVR) type system to recharge (i.e., replenish the value) when the balance reaches a predetermined threshold amount, such as, e.g., but not limited to, five dollars ($5). In an exemplary embodiment, the amount of the promotional minutes may be less than the amount of the threshold, therefore, all calls made with promotional minutes may be prompted for recharge.

Exemplary Flows and Functions

a. Exemplary Customer Service (CS) or integrated voice response (IVR) functions
   a. Exemplary functions may include collecting ANI, PIN, and Store name;
   b. Exemplary functions may include joining pre-created PIN and ANI;
   c. Exemplary functions may include activating 100 free promo minutes;
   d. Exemplary functions may include Accepting and facilitating incoming activation and recharging PINs via IVR or Customer Service;
   e. Exemplary functions may include charging and accepting payment;
      i. Post activation;
         1. Exemplary functions may include accepting and charging users account via credit card;
            a. Exemplary functions may include setting up Auto recharge at users request;
            b. Exemplary functions may include setting up ability for IVR recharge;
         2. Exemplary functions may include accepting and charging users account via ECP;
b. Exemplary Service Provider Platform functions
   a. Exemplary functions may include setting up target balance and notification prompt for recharging the account;
   b. Exemplary functions may include transferring user to CS rep or IVR for recharging;
      i. After 1^{st} time charge, setting up the account ability to recharge via IVR;
   c. Exemplary functions may include recharging;
      i. Auto Recharging;
         1. Presetting amount to be recharged when account hits preset threshold;
      ii. IVR Recharge;
         1. User interacting with IVR to recharge account;
      iii. Assisted Recharge;
         1. User interacting with CS rep to recharge account;
   d. Exemplary functions may include setting up Account expiration:
      i. Utilizing existing expiration policies;
   e. Exemplary functions may include setting up Surcharge for calls (may be all calls) made via calling card with appropriate surcharges as required and directed;
      i. DNIS Surcharge;
   f. Exemplary functions may include upon calling from ATS phone;
      i. After a customer activates the phone/account but has not charged the account;
         1. User may be prompted via IVR to recharge the account;
            a. If user response is yes, the user may be transferred to Customer Service or IVR so the billing information can be captured;
            b. If user response is no, the user may be prompted to enter the number they wish to call;
      ii. After a customer has charged and/or recharged the account;
         1. User may be prompted to enter the number they wish to dial or press a predetermined keypad button to go to customer service;
   g. Exemplary functions may include upon calling from any phone via calling card (see “f” above as procedure may be the same);
c. Exemplary Debit/Operations
   a. Exemplary functions may include utilizing appropriate Anti-Fraud procedures to catch fraud;
   b. Exemplary functions may include utilizing existing reports;
      i. How many accounts have been activated by Vendor by user;

ii. How many accounts have been recharged by Vendor by user;

Exemplary Account Record

| | Customer | | $ Charged |
|---|---|---|---|
| | Area-code & | $ Charged | (Total-life |
| Vendor | Exchange | (period) | of account) |
| Vendor Name | 845624 | $5.00 | $450.00 |
| (e.g., Staples) | | | |

c. Exemplary functions may include creating program;
d. Exemplary functions may include creating 2 access numbers;
   i. Branded IDT service access number may be hard coded into phone hardware (number TBD);
   ii. Branded IDT service access number may be printed on calling card (number TBD);
e. Exemplary functions may include generating Calling Card PINs.
   Exemplary Customer Experience—FLOW (Phone Activation)
a. Customer may purchase ATS cordless phone with IDT (LDS) feature built in;
b. Customer may press the “talk” button followed by the LDS button on the ATS phone;
   a. Customer may be automatically directed to the IDT platform (DNIS);
      i. Customer may choose to “charge” the product (via rep or IVR);
      ii. Customer may enter all necessary information;
   b. Customer may hang up and may be now allowed to utilize free promotional minutes;
      i. Customer may press LDS button;
         1. The phone may automatically call the platform;
         2. ANI recognition may allow the user to directly enter the number they wish to dial or be transferred to a rep for account “Charging”;
         3. Call may complete as standard until promotional minutes run out;
            a. User may be prompted with each call to “charge” the account;
      ii. Customer may go to another phone and may utilize the phone card provided;
         1. The incoming call IVR may request the PIN;
            a. User may enter information;
         2. The incoming call IVR may request the number to dial or transfer to CS;
            a. User may enter information;
            b. Call may complete as standard until promotional minutes run out;
            c. Each call into the platform this way may be surcharged $0.025;
   c. Customer balance may hit targeted point;
      i. IVR may prompt user to recharge the account;
      ii. Platform may give user the option to recharge at this point;
         1. If user selects Yes, Call may be directed to CS where necessary information may be collected;
         2. If validate via fraud procedure account may be credited;
      iii. User may decline to recharge;
         1. User may continue to use up remainder of balance, and may be prompted to recharge with each call;
   d. User's prepaid balance may run out;
      i. Exemplary functions may include upon hitting the “LDS” button, User may be automatically transferred to CS;
      ii. Exemplary functions may include upon utilizing the calling card, User may be automatically transferred to CS.
         An Example Telecommunications Environment

The present invention is described in terms of an example environment. The example environment may include a multiple carriers telecommunications environment. In an exemplary embodiment, the device according to an exemplary embodiment, may be a telephony device which may be coupled to a telecommunications carrier according to any of a number of various conventional methods including, e.g., a wired line, a wireless, CATV, or other means of connecting to communications services. According to an exemplary embodiment, the carriers may use any of a range of well known circuit switched and packet switched technologies, as well as telephony, video, and/or other data. The multiple telecommunications carriers may include US domestic entities (see Definitions below in Table 1) such as, e.g., ILECs, CLECs, IXCs, NGTs and Enhanced Service Providers (ESPs), as well as global entities such as PTTs and NEs, recognized by those skilled in the art. In addition, as used herein a telecommunications system may include domestic systems used by entities such as, e.g., ILECs, CLECs, IXCs and Enhanced Service Providers (ESPs), as well as global systems recognized by those skilled in the art.

In an exemplary embodiment, one network element may be a pre-paid telecommunications services provider which many receive calls initiated by a user depressing an LDS autokey 404 button on a device 402 originating a call from a user on a LEC facility to the prepaid telecommunications services provider which may be any of a number of the above entities, which may then provide transport for the originated call over IXC facilities and may terminate the call at the desired dialed telephone number. Unlike, conventional pre-paid calling card services, no lengthy access number must be dialed, instead, only a single LDS auto-key button is pressed by the user. Also, rather than needing to enter a lengthy PIN, a pre-programmed unique identifier associated with both the device 402 and account which tracks the available value associated with the account provides the necessary identification to allow the pre-paid call to be completed. Thus, the user need not enter a lengthy access number, and another lengthy PIN, in order to gain access to pre-paid telecommunications services.

In the exemplary embodiment, data and voice traffic may be transported over a heterogeneous network including telecommunications equipment and facilities of any of a number of the carriers or entities described herein.

In one exemplary embodiment, a user may access the account information associated with a device 402 via, e.g., but not limited to, a telephone call, and/or a web page, or other browser to replenish, or vary the profile of services associated with the device 402.

Although the invention is described in terms of this example environment, it is important to note that description in these terms is provided for purposes of illustration only. It is not intended that the invention be limited to this example environment or to the precise inter-operations between the above-noted entities and devices. In fact, after reading the following description, it will become apparent to a person skilled in the relevant art how to implement the invention in alternative environments.

### Definitions

Table 1 below defines common telecommunications terminology. These terms may be used throughout the remainder of the description of the invention.

TABLE 1

| Term | Definition |
|---|---|
| automatic number | A telephone service that transmits the billing |
| identification (ANI) | number (BN) and the telephone number of the |
| | incoming call. ANI identifies the calling |
| | party for toll call billing and enables the |
| | call to be routed to the appropriate long |
| | distance service provider. ISDN supports |
| | ANI by carrying the calling telephone number |
| | in the D channel. ACD systems use the billing |
| | number to query a database and retrieve the |
| | customer's records. |
| access tandem (AT) | An AT is a class 3/4 switch may be used to |
| | switch calls between EOs in a LATA. An AT |
| | may provide subscribers access to the |
| | IXCs, to provide long distance calling |
| | services. An access tandem may be a network |
| | node. Other network nodes may include, for |
| | example, but not limited to, a CLEC, or |
| | other enhanced services provider (ESP), an |
| | international gateway or global point-of- |
| | presence (GPOP), or an intelligent |
| | peripheral(IP). |
| bearer (B) channels | Bearer (B) channels are digital channels may |
| | be used to carry both digital voice and |
| | digital data information. An ISDN bearer |
| | channel is 64,000 bits per second, which |
| | can carry PCM-digitized voice or data. |
| called party | The called party is the caller receiving a |
| | call sent over a network at the destination |
| | or termination end. |
| calling party | The calling party is the caller placing a |
| | call over any kind of network from the |
| | origination end. |
| central office (CO) | A CO is a facility that houses an EO homed. |
| | EOs are often called COs. |
| class 1 switch | A class 1 switching office, the Regional |
| | Center(RC), is the highest level of local |
| | and long distance switching, or “office |
| | of last resort” to complete a call. |
| class 3 switch | A class 3 switching office is a Primary |
| | Center (PC); an access tandem (AT) has |
| | class 3 functionality. |
| class 4 switch | A class 4 switching office is a Toll Center |
| | (TC) if operators is present or else a Toll |
| | Point (TP); an access tandem (AT) has class |
| | 4 functionality. |
| class 5 switch | A class 5 switching office is an end office |
| | (EO) or the lowest level of local and long |
| | distance switching, a local central office. |
| | The switch closest to the end subscriber. |
| competitive LEC | CLECs are telecommunications services |
| (CLEC) | providers of local services that can compete |
| | with ILECs. Level 3 Communications is an |
| | example. A CLEC may or may not handle IXC |
| | services as well. |
| competitive access | Teligent and Winstar were examples. |
| providers (CAPS) | |
| customer premises | CPE refers to devices residing on the |
| equipment (CPE) | premises of a customer and used to connect |
| | to a telephone network, including ordinary |
| | telephones, key telephone systems, PBXs, |
| | video conferencing devices and modems. |
| digitized data (or | Digitized data refers to analog data that |
| digital data) | has been sampled into a binary representation |
| | (i.e., comprising sequences of 0's and |
| | 1's). Digitized data is less susceptible |
| | to noise and attenuation distortions because |
| | it is more easily regenerated to reconstruct |
| | the original signal. |
| egress end office | The egress EO is the node or destination |
| | EO with a direct connection to the called |
| | party, the termination point. The called |
| | party is “homed” to the egress EO. |
| egress | Egress refers to the connection from a |
| | called party or termination at the |
| | destination end of a network, to the |
| | serving wire center (SWC). |
| end office (EO) | An EO is a class 5 switch used to switch |
| | local calls within a LATA. Subscribers of |
| | the LEC are connected (“homed”) to |
| | EOs, meaning that EOs are the last switches |
| | to which the subscribers are connected. |
| Enhanced Service | A network services provider. |
| Provider (ESP) | |
| equal access | 1+ dialing as used in US domestic calling |
| | for access to any long distance carrier as |
| | required under the terms of the modified |
| | final judgment (MFJ) requiring divestiture |
| | of the Regional Bell Operating Companies |
| | (RBOCs) from their parent company, AT&T. |
| global point of | A GPOP refers to the location where |
| presence (GPOP) | international telecommunications facilities |
| | and domestic facilities interface, an |
| | international gateway POP. |
| incumbent LEC | ILECs are traditional LECs in the US, which |
| (ILEC) | are the Regional Bell Operating Companies |
| | (RBOCs). Bell South and US West are |
| | examples. ILEC can also stand for an |
| | independent LEC such as a GTE. |
| ingress end office | The ingress EO is the node or serving wire |
| | center (SVC) with a direct connection to the |
| | calling party, the origination point. The |
| | calling party is “homed” to the |
| | ingress EO. |
| ingress | Ingress refers to the connection from a |
| | calling party or origination. |
| integrated service | An ISDN Basic Rate Interface (BRI) line |
| digital network | provides 2 bearer B channels and 1 data D |
| (ISDN) basic rate | line (known as “2B + D” over one or |
| interface (BRI) line | two pairs) to a subscriber. |
| integrated services | ISDN is a network that provides a standard |
| digital network | for communications (voice, data and |
| (ISDN) | signaling), end-to-end digital transmission |
| | circuits, out-of-band signaling, and a |
| | features significant amount of bandwidth. |
| inter machine trunk | An inter-machine trunk (IMT) is a circuit |
| (IMT) | between two commonly-connected switches. |
| inter-exchange | IXCs are US domestic long distance |
| carrier (IXC) | telecommunications services providers. |
| | AT&T, MCI, Sprint, are examples. |
| internet protocol | IP is part of the TCP/IP protocols. It is |
| (IP) | used to recognize incoming messages, route |
| | outgoing messages, and keep track of |
| | Internet node addresses (using a number to |
| | specify a TCP/IP host on the Internet). IP |
| | corresponds to the network layer of OSI. |
| Internet service | An ISP is a company that provides Internet |
| provider (ISP) | access to subscribers. |
| ISDN primary rate | An ISDN Primary Rate Interface (PRI) line |
| interface (PRI) | provides the ISDN equivalent of a T1 circuit. |
| | The PRI delivered to a customer's |
| | premises can provide 23B + D (in North |
| | America) or 30B + D (in Europe) channels |
| | running at 1.544 megabits per second and |
| | 2.048 megabits per second, respectively. |
| local exchange | LECs are local telecommunications services |
| carrier (LEC) | providers. Bell Atlantic and US West are |
| | examples. |
| local access and | A LATA is a region in which a LEC offers |
| transport area | services. There are over 160 LATAs of these |
| (LATA) | local geographical areas within the |
| | United States. |
| local area network | A LAN is a communications network providing |
| (LAN) | connections between computers and peripheral |
| | devices (e.g., printers and modems) over a |
| | relatively short distance (e.g., within a |
| | building) under standardized control. |
| modified final | Modified final judgment (MFJ) was the |
| judgment (MFJ) | decision requiring divestiture of the |
| | Regional Bell Operating Companies (RBOCs) |
| | from their parent company, AT&T. |
| network node | A network node is a generic term for the |
| | resources in a telecommunications network, |
| | including switches, DACS, regenerators, etc. |
| | Network nodes essentially include all |
| | non-circuit (transport) devices. Other |
| | network nodes can include, for example, |
| | equipment of a CLEC, or other enhanced |
| | service provider (ESP), a point-of-presence |
| | (POP), an international gateway or global |
| | point-of-presence (GPOP). |
| new entrant (NE) | A new generation global telecommunications. |
| next generation | A new telecommunications services provider, |
| telephone (NGT) | especially IP telephony providers. Examples |
| | are Level 3 and Qwest. |
| packetized voice or | One example of packetized voice is voice over |
| voice over a | internet protocol (VOIP). Voice over packet |
| backbone | refers to the carrying of telephony or |
| | voice traffic over a data network, e.g. |
| | voice over frame, voice over ATM, voice over |
| | Internet Protocol (IP), over virtual private |
| | networks (VPNs), voice over a backbone, etc. |
| Pipe or dedicated | A pipe or dedicated communications facility |
| communications | connects an ISP to the internet. |
| facility | |
| point of presence | A POP refers to the location within a LATA |
| (POP) | where the IXC and LEC facilities interface. |
| point-to-point | A virtual private networking protocol, |
| tunneling protocol | point-to-point tunneling protocol (PPTP), |
| (PPTP) | can be used to create a “tunnel” between |
| | a remote user and a data network. A tunnel |
| | permits a network administrator to extend a |
| | virtual private network (VPN) from a server |
| | (e.g., a Windows NT server) to a data network |
| | (e.g., the Internet). |
| point-to-point (PPP) | PPP is a protocol permitting a computer to |
| protocol | establish a connection with the Internet |
| | using a modem. PPP supports high-quality |
| | graphical front ends, like Netscape. |
| postal telephone | State regulated telephone companies, many |
| telegraph (PTT) | of which are being deregulated. NTT is an |
| | example. |
| private branch | A PBX is a private switch located on the |
| exchange (PBX) | premises of a user. The user is typically |
| | a private company which desires to provide |
| | switching locally. |
| private line with a | A private line is a direct channel |
| dial tone | specifically dedicated to a customer's |
| | use between two specificed points. A private |
| | line with a dial tone can connect a PBX or |
| | an ISP's access concentrator to an |
| | end office (e.g. a channelized T1 or PRI). |
| | A private line can also be known as a |
| | leased line. |
| public switched | The PSTN is the worldwide switched voice |
| telephone network | network. |
| (PSTN) | |
| regional Bell | RBOCs are the Bell operating companies |
| operating companies | providing LEC services after being divested |
| (RBOCs) | from AT&T. |
| signaling system 7 | SS7 is a type of common channel interoffice |
| (SS7) | signaling (CCIS) used widely throughout the |
| | world. The SS7 network provides the |
| | signaling functions of indicating the |
| | arrival of calls, transmitting routing and |
| | destination signals, and monitoring line |
| | and circuit status. |
| switching hierarchy | An office class is a functional ranking of |
| or office | a telephone central office switch depending |
| classification | on transmission requirements and hierarchical |
| | relationship to other switching centers. |
| | Prior to AT&T's divestiture of the RBOCs, |
| | an office classification was the number |
| | assigned to offices according to their |
| | hierarchical function in the U.S. public |
| | switched network (PSTN). The following class |
| | numbers are used: |
| | class 1 = Regional Center(RC), |
| | class 2 = Sectional Center (SC), |
| | class 3 = Primary Center (PC), |
| | class 4 = Toll Center (TC) if |
| | operators are present or else Toll Point (TP), |
| | class 5 = End Office (EO) a local central |
| | office. Any one center handles traffic from |
| | one to two or more centers lower in the |
| | hierarchy. Since divestiture and with more |
| | intelligent software in switching offices, |
| | these designations have become less firm. |
| | The class 5 switch was the closest to the |
| | end subscriber. Technology has distributed |
| | technology closer to the end user, diffusing |
| | traditional definitions of network switching |
| | hierarchies and the class of switches. |
| telecommunications | A LEC, a CLEC, an IXC, an Enhanced Service |
| carrier | Provider (ESP), an intelligent peripheral |
| | (IP), an international/global point-of-presence |
| | (GPOP), i.e., any provider of |
| | telecommunications services. |
| transmission control | TCP is an end-to-end protocol that operates |
| protocol (TCP) | at the transport and sessions layers of OSI, |
| | providing delivery of data bytes between |
| | processes running in host computers via |
| | separation and sequencing of IP packets. |
| transmission control | TCP/IP is a protocol that provides |
| protocol/internet | communications between interconnected |
| protocol (TCP/IP) | networks. The TCP/IP protocol is widely |
| | used on the Internet, which is a network |
| | comprising several large networks |
| | connected by high-speed connections. |
| trunk | A trunk connects an access tandem (AT) to |
| | an end office (EO). |
| wide area network | A WAN is a data network that extends a LAN |
| (WAN) | over the circuits of a telecommunications |
| | carrier. The carrier is typically a common |
| | carrier. A bridging switch or a router is |
| | used to connect the LAN to the WAN. |

### Introduction

Exemplary Telecommunications Network—Voice Network—Simple Voice Network

FIG. 1 is a block diagram providing an overview of a standard telecommunications network 100 providing local exchange carrier (LEC) services within one or more local access and transport areas (LATAs). Telecommunications network 100 can provide a switched voice connection from a calling party 102 to a called party 110. FIG. 1 is shown to also include a private branch exchange 112 which can provide multiple users access to LEC services by, e.g., a private line. Calling party 102 and called party 110 can be ordinary telephone equipment, key telephone systems, a private branch exchange (PBX) 112, or applications running on a host computer. Network 100 can be used for modem access as a data connection from calling party 102 to, for example, an Internet service provider (ISP) (not shown). Network 100 can also be used for access to, e.g., a private data network. For example, calling party 102 can be an employee working on a notebook computer at a remote location who is accessing his employer's private data network through, for example, a dial-up modem connection.

FIG. 1 includes end offices (EOs) 104 and 108. EO 104 is called an ingress EO because it provides a connection from calling party 102 to public switched telephone network (PSTN) facilities. EO 108 is called an egress EO because it provides a connection from the PSTN facilities to a called party 110. In addition to ingress EO 104 and egress EO 108, the PSTN facilities associated with telecommunications network 100 include an access tandem (AT) (not shown) at points of presence (POPs) 132 and 134 that can provide access to, e.g., one or more inter-exchange carriers (IXCs) 106 for long distance traffic, see FIG. 2. Alternatively, it would be apparent to a person having ordinary skill in the art that IXC 106 could also be, for example, a CLEC, or other enhanced service provider (ESP), an international gateway or global point-of-presence (GPOP), or an intelligent peripheral (IP).

FIG. 1 also includes a private branch exchange (PBX) 112 coupled to EO 104. PBX 112 couples calling parties 124 and 126, fax 116, client computer 118 and associated modem 130, and local area network 128 having client computer 120 and server computer 122 coupled via an associated modem 130. PBX 112 is a specific example of a general class of telecommunications devices located at a subscriber site, commonly referred to as customer premises equipment (CPE).

Network 100 also includes a common channel interactive signaling (CCIS) network for call setup and call tear down. Specifically, FIG. 1 includes a Signaling System 7 (SS7) signaling network 114.

Detailed Voice Network

FIG. 2 is a block diagram illustrating an overview of a standard telecommunications network 200, providing both LEC and IXC carrier services between subscribers located in different LATAs. Telecommunications network 200 is a more detailed version of telecommunications network 100. Calling party 102a and called party 110a are coupled to EO switches 104a and 108a, respectively. In other words, calling party 102a is homed to ingress EO 104a in a first LATA, whereas called party 110a is homed to an egress EO 108a in a second LATA. Calls between subscribers in different LATAs are long distance calls that are typically routed to IXCs. Sample IXCs in the United States include AT&T, MCI and Sprint.

Telecommunications network 200 includes access tandems (AT) 206 and 208. AT 206 provides connection to points of presence (POPs) 132a, 132b, 132c and 132d. IXCs 106a, 106b and 106c provide connection between POPs 132a, 132b and 132c (in the first LATA) and POPs 134a, 134b and 134c (in the second LATA). Competitive local exchange carrier (CLEC) 214 provides an alternative connection between POP 132d and POP 134d. POPs 134a, 134b, 134c and 134d, in turn, are connected to AT 208, which provides connection to egress EO 108a. Called party 110a can receive calls from EO 108a, which is its homed EO.

Alternatively, it would be apparent to a person having ordinary skill in the art that an AT 206 can also be, for example, a CLEC, or other enhanced service provider (ESP), an international gateway or global point-of-presence (GPOP), or an intelligent peripheral.

Network 200 also includes calling party 102c homed to CLEC switch 104c. Following the 1996 Telecommunications Act in the U.S., CLECs gained permission to compete for access within the local RBOCs territory. RBOCs are commonly referred to as incumbent local exchange carriers (ILECs).

Network 200 further may include a fixed wireless CLEC 209. Fixed wireless CLEC 209 includes a wireless transceiver/receiver radio frequency (RF) tower 210 in communication over an RF link to a subscriber transciever RF tower 212. Subscriber RF tower 212 is depicted coupled to a CPE box, PBX 112b. PBX 112b couples calling parties 124b and 126b, fax 116b, client computer 118b and associated modem 130b, and local area network 128b having client computer 120b and server computer 122b coupled via an associated modem 130b.

Network 200 also includes called party 110a, a fax 116a, client computer 118a and associated modem 130a, and cellular communications RF tower 202 and associated cellular subscriber called party 204, all coupled to EO 108a, as shown.

EO 104a, 108a and AT 206, 208 are part of a switching hierarchy. EO 104a is known as a class 5 office and AT 208 is a class 3/4 office switch. Prior to the divestiture of the regional Bell Operating Companies (RBOCs) from AT&T following the modified final judgment, an office classification was the number assigned to offices according to their hierarchical function in the U.S. public switched network (PSTN). An office class is a functional ranking of a telephone central office switch depending on transmission requirements and hierarchical relationship to other switching centers. A class 1 office was known as a Regional Center (RC), the highest level office, or the “office of last resort” to complete a call. A class 2 office was known as a Sectional Center (SC). A class 3 office was known as a Primary Center (PC). A class 4 office was known as either a Toll Center (TC) if operators were present, or otherwise as a Toll Point (TP). A class 5 office was an End Office (EO), i.e., a local central office, the lowest level for local and long distance switching, and was the closest to the end subscriber. Any one center handles traffic from one or more centers lower in the hierarchy. Since divestiture and with more intelligent software in switching offices, these designations have become less firm. Technology has distributed functionality closer to the end user, diffusing traditional definitions of network hierarchies and the class of switches.

Connectivity to Internet Service Providers (ISPs)

In addition to providing a voice connection from calling party 102a to called party 110a, the PSTN can provide calling party 102a a data connection to an ISP (i.e. similar to client 118b).

Network 200 can also include an Internet service provider (ISP) (not shown) which could include a server computer 122 coupled to a data network 142 as will be discussed further below with reference to FIG. 3. The Internet is a well-known, worldwide network comprising several large networks connected together by data links. These links can include, for example, Integrated Digital Services Network (ISDN), T1, T3, FDDI and SONET links. Alternatively, an internet can be a private network interconnecting a plurality of LANs and/or WANs, such as, for example, an intranet. An ISP can provide Internet access services for subscribers such as client 118b.

To establish a connection with an ISP, client 118b can use a host computer connected to a modem (modulator/demodulator) 130b. The modem can modulate data from the host computer into a form (traditionally an analog form) for transmission to the LEC facilities. Typically, the LEC facilities convert the incoming analog signal into a digital form. In one embodiment, the data is converted into the point-to-point protocol (PPP) format. (PPP is a well-known protocol that permits a computer to establish a connection with the Internet using a standard modem. It supports high-quality, graphical user-interfaces.) As those skilled in the art will recognize, other formats are available, including, e.g., a transmission control program, internet protocol (TCP/IP) packet format, a user datagram protocol, internet protocol (UDP/IP) packet format, an asynchronous transfer mode (ATM) cell packet format, a serial line interface protocol (SLIP) protocol format, a point-to-point (PPP) protocol format, a point-to-point tunneling protocol (PPTP) format, a NETBIOS extended user interface (NETBEUI) protocol format, an Appletalk protocol format, a DECnet, BANYAN/VINES, an internet packet exchange (IPX) protocol format, and an internet control message protocol (ICMP) protocol format.

Communications Links

Note that FIGS. 1, 2 and other figures described herein include lines which may refer to communications lines or which may refer to logical connections between network nodes, or systems, which are physically implemented by telecommunications carrier devices. These carrier devices include circuits and network nodes between the circuits including, for example, digital access and cross-connect system (DACS), regenerators, tandems, copper wires, and fiber optic cable. It would be apparent to persons having ordinary skill in the art that alternative communications lines can be used to connect one or more telecommunications systems devices. Also, a telecommunications carrier as defined here, can include, for example, a LEC, a CLEC, an IXC, an Enhanced Service Provider (ESP), a global or international services provider such as a global point-of-presence (GPOP), and an intelligent peripheral.

EO 104a and AT 206 are connected by a trunk. A trunk connects an AT to an EO. A trunk can be called an inter machine trunk (IMT). AT 208 and EO 108a are connected by a trunk which can be an IMT.

Referring to FIG. 1, EO 104 and PBX 112 can be connected by a private line with a dial tone. A private line can also connect an ISP (not shown) to EO 104, for example. A private line with a dial tone can be connected to a modem bay or access converter equipment at the ISP. Examples of a private line are a channelized T1 or integrated services digital network (ISDN) primary rate interface (PRI). An ISP can also attach to the Internet by means of a pipe or dedicated communications facility. A pipe can be a dedicated communications facility. A private line can handle data modem traffic to and from an ISP.

Trunks can handle switched voice traffic and data traffic. For example, trunks can include digital signals DS1-DS4 transmitted over T1-T4 carriers. Table 2 provides typical carriers, along with their respective digital signals, number of channels, and bandwidth capacities.

TABLE 2

| | Number of | Designation | Bandwidth in Megabits |
|---|---|---|---|
| Digital signal | channels | of carrier | per second (Mbps) |
| DS0 | 1 | None | 0.064 |
| DS1 | 24 | T1 | 1.544 |
| DS2 | 96 | T2 | 6.312 |
| DS3 | 672 | T3 | 44.736 |
| DS4 | 4032 | T4 | 274.176 |

Alternatively, trunks can include optical carriers (OCs), such as OC-1, OC-3, etc. Table 3 provides typical optical carriers, along with their respective synchronous transport signals (STSs), ITU designations, and bandwidth capacities.

TABLE 3

| | Electrical | | |
|---|---|---|---|
| | signal, or | International | |
| | synchronous | Telecommunications | Bandwidth in |
| Optical carrier | transport | Union (ITU) | Megabits per |
| (OC) signal | signal (STS) | terminology | second (Mbps) |
| OC-1 | STS-1 | | 51.84 |
| OC-3 | STS-3 | STM-1 | 155.52 |
| OC-9 | STS-9 | STM-3 | 466.56 |
| OC-12 | STS-12 | STM-4 | 622.08 |
| OC-18 | STS-18 | STM-6 | 933.12 |
| OC-24 | STS-24 | STM-8 | 1244.16 |
| OC-36 | STS-36 | STM-12 | 1866.24 |
| OC-48 | STS-48 | STM-16 | 2488.32 |

As noted, a private line is a connection that can carry data modem traffic. A private line can be a direct channel specifically dedicated to a customer's use between two specified points. A private line can also be known as a leased line. In one embodiment, a private line is an ISDN/primary rate interface (ISDN PRI) connection. An ISDN PRI connection can include a single signal channel (called a data or D channel) on a T1, with the remaining 23 channels being used as bearer or B channels. (Bearer channels are digital channels that bear voice and data information.) If multiple ISDN PRI lines are used, the signaling for all of the lines can be carried over a single D channel, freeing up the remaining lines to carry only bearer channels.

Telecommunications Traffic

Telecommunications traffic can be sent and received from any network node of a telecommunications carrier. A telecommunications carrier can include, for example, a LEC, a CLEC, an IXC, and an Enhanced Service Provider (ESP). In an embodiment, this traffic can be received from a network node which is, for example, a class 5 switch, such as EO 104a, or from a class 3/4 switch, such as AT 206. Alternatively, the network system can also be, for example, a CLEC, or other enhanced service provider (ESP), an international gateway or global point-of-presence (GPOP), or an intelligent peripheral.

Voice traffic refers, for example, to a switched voice connection between calling party 102a and called party 110a. It is important to note that this is on a point-to-point dedicated path, i.e., that bandwidth is allocated whether it is being used or not. A switched voice connection is established between calling party 102a and EO 104a, then to AT 206 then over an IXC's network such as that of IXC 106a to AT 208 and then to EO 108a and over a trunk to called party 110a. In another embodiment, AT 206 or IXC 106a can also be, for example, a CLEC, or other enhanced service provider (ESP), an international gateway or global point-of-presence (GPOP), or an intelligent peripheral.

It is possible that calling party 102a is a computer with a data connection to a server over the voice network. Data traffic refers, for example, to a data connection between a calling party 102a (using a modem) and a server 122b that could be part of an ISP. A data connection can be established, e.g., between calling party 102a and EO 104a, then to AT 206, then to CLEC 214, then over a fixed wireless CLEC 209 link to PBX 112b to a modem 130b associated with server 122b.

A voice-over-Internet Protocol (VOIP) call may also be made and telephony and other data may be delivered over a data network as shown in FIG. 3.

SS7 Signaled Call Flow

To initiate a call in an SS7 telecommunications network, a calling party using a telephone connected to an ingress EO switch, dials a telephone number of a called party. The telephone number is passed from the telephone to the SSP at the ingress EO of the calling party's local exchange carrier (LEC). First, the SSP can process triggers and internal route rules based on satisfaction of certain criteria. Second, the SSP can initiate further signaling messages to another EO or access tandem (AT), if necessary. The signaling information can be passed from the SSP to STPs, which route the signals between the ingress EO and the terminating end office, or egress EO. The egress EO has a port designated by the telephone number of the called party. The call is set up as a direct connection between the EOs through tandem switches if no direct trunking exists or if direct trunking is full. If the call is a long distance call, i.e., between a calling party and a called party located in different local access transport areas (LATAs), then the call is connected through an inter exchange carrier (IXC) switch. Such a long distance call is commonly referred to as an inter-LATA call. LECs and IXCs are collectively referred to as the public switched telephone network (PSTN).

An Exemplary Computer System

FIG. 5 depicts an exemplary embodiment of a computer system that may be used in computing devices such as, e.g., but not limited to, client or server devices according to an exemplary embodiment of the present invention. FIG. 5 depicts an exemplary embodiment of a computer system that may be used as client device 102, or a server device 104, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 500 is shown in FIG. 5, depicting an exemplary embodiment of a block diagram of an exemplary computer system useful for implementing the present invention. Specifically, FIG. 5 illustrates an example computer 500, which in an exemplary embodiment may be, e.g., (but not limited to) a personal computer (PC) system running an operating system such as, e.g., (but not limited to) WINDOWS MOBILETM for POCKET PC, or MICROSOFT® WINDOWS® NT/98/2000/XP/CE/, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 500 is shown in FIG. 5. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 5.

The computer system 500 may include one or more processors, such as, e.g., but not limited to, processor(s) 504. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, compact disk, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 500.

Computer 500 may also include an input device such as, e.g., (but not limited to) a mouse or other pointing device such as a digitizer, and a keyboard or other data entry device (none of which are labeled).

Computer 500 may also include output devices, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526 (e.g., but not limited to a channel). This channel 526 may carry signals 528, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 514, a hard disk installed in hard disk drive 512, and signals 528, etc. These computer program products may provide software to computer system 500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 508 and/or the secondary memory 510 and/or removable storage units 514, also called computer program products. Such computer programs, when executed, may enable the computer system 500 to perform the features of the present invention as discussed herein. In particular, the computer programs, when executed, may enable the processor 504 to provide a method to resolve conflicts during data synchronization according to an exemplary embodiment of the present invention. Accordingly, such computer programs may represent controllers of the computer system 500.

In another exemplary embodiment, the invention may be directed to a computer program product comprising a computer readable medium having control logic (computer software) stored therein. The control logic, when executed by the processor 504, may cause the processor 504 to perform the functions of the invention as described herein. In another exemplary embodiment where the invention may be implemented using software, the software may be stored in a computer program product and loaded into computer system 500 using, e.g., but not limited to, removable storage drive 514, hard drive 512 or communications interface 524, etc. The control logic (software), when executed by the processor 504, may cause the processor 504 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., but not limited to IEEE 802.11g-2003, etc.), etc.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method comprising:
receiving an automatic number identification (ANI) at an ANI recognition system of a service provider platform from a user, wherein the user having previously acquired a communications device, wherein a pre-paid service has been bundled with the device, and wherein, upon the user having depressed a long distance service (LDS) auto-key having been pre-programmed with a feature code and dialing sequence comprising exposing the ANI.

2. The method according to claim 1, further comprising:
upon an initial use of the communications device by the user, upon the user having depressed the LDS auto-key, receiving at the service provider platform at least one of:
retailer identification;
an account number; and/or
the automatic number identification (ANI) of the user.

3. The method according to claim 2, wherein said retailer identification may be used for revenue sharing between the service provider and a retailer.

4. The method according to claim 1, further comprising:
allowing the user to place a telecommunications call using a value of calling minutes until depletion.

5. The method according to claim 4, further comprising:
pre-provisioning an account associated with the communications device of the user a promotional amount of said value of said calling minutes.

6. The method according to claim 4, further comprising:
prompting the user to replenish the value upon said value reaching a pre-determined threshold.

7. The method according to claim 6, wherein said prompting comprises prompting via an interactive voice response (IVR) type system.

8. The method according to claim 4, further comprising:
receiving from the user an agreement to automatically replenish said account of the user upon occurrence of at least one criterion.

9. The method according to claim 8, wherein said criterion comprises a value of said account reaching an automatic replenishment threshhold level.

10. The method according to said claim 8, wherein said automatic replenishment threshold level is user selectable.

11. The method according to said claim 8, wherein said automatic replenishment comprises debiting a financial account of the user comprising at least one of:
a monetary account;
a money market account;
a savings account;
a debit card account;
a checking account; and/or
a credit card account.

12. The method according to claim 1, wherein the feature code and dialing sequence of the communications device comprising:
suppressing dial tone and ring back.

13. A machine-readable medium that provides instructions, which when executed by a computing platform, cause said computing platform to perform operations comprising a method comprising:
receiving an automatic number identification (ANI) at an ANI recognition system of a service provider platform from a user, wherein the user having previously acquired a communications device, wherein a pre-paid service has been bundled with the device, and wherein, upon the user having depressed a long distance service (LDS) auto-key having been pre-programmed with a feature code and dialing sequence comprising exposing the ANI.

14. The machine readable medium according to claim 13, wherein the method further comprises:
upon an initial use of the communications device by the user, upon the user having depressed the LDS auto-key, receiving at the service provider platform at least one of:
retailer identification;
an account number; and/or
the automatic number identification (ANI) of the user.

15. The method according to claim 14, wherein said retailer identification may be used for revenue sharing between the service provider and a retailer.

16. The machine readable medium according to claim 13, wherein the method further comprises:
allowing the user to place a telecommunications call using a value of calling minutes until depletion.

17. The machine readable medium according to claim 16, wherein the method further comprises:
pre-provisioning an account associated with the phone device of the user a promotional amount of said value of said calling minutes.

18. The machine readable medium according to claim 16, wherein the method further comprises:
prompting the user to replenish the value upon said value reaching a pre-determined threshold.

19. The machine readable medium according to claim 18, wherein said prompting of the method comprises prompting via an interactive voice response (IVR) type system.

20. The machine readable medium according to claim 16, wherein the method further comprises:
receiving from the user an agreement to automatically replenish said account of the user upon occurrence of at least one criterion.

21. The machine readable medium according to claim 20, wherein said criterion comprises a value of said account reaching an automatic replenishment threshhold level.

22. The machine readable medium according to said claim 21, wherein said automatic replenishment threshold level of the method is user selectable.

23. The machine readable medium according to said claim 20, wherein said automatic replenishment of the method comprises debiting a financial account of the user comprising at least one of:
a monetary account;
a money market account;
a savings account;
a debit card account;
a checking account; and/or
a credit card account.

24. The machine readable medium according to claim 13, wherein the feature code and dialing sequence of the communications device comprises:
suppressing dial tone and ring back.

25. A telecommunications apparatus comprising:
a communications device comprising:
a long distance service (LDS) auto-key adapted to, upon user depression, to suppress dial tone and ring back, and to expose an automatic number identification (ANI) to an ANI recognition system of a prepaid service provider platform.

26. The telecommunications apparatus of claim 25, wherein said communications device comprises at least one of:
a corded telephone;
a cordless telephone;
a digital spread spectrum (DSS) cordless telephone;
a 2.4 GHz DSS cordless telephone;
a wired telephone;
a wireless telephone;
a mobile telephone;
a personal digital assistant (PDA);
a computing device;
a single unit device;
a multi-unit device;
a multi-handset device;
a cellular telephone device;
a telephony device;
a base station device; and/or
an extension base device.

27. The telecommunications apparatus of claim 25, further comprising:
a base station adapted to receive said communications device; and
at least a first extension base in wireless communication with said base station, adapted to receive a second of said communications devices.

28. The telecommunications apparatus of claim 27, further comprising:
at least a second extension base in wireless communication with said base station, adapted to receive a third of said communications devices.

29. The method according to claim 1, further comprising:
allowing the user to use a value associated with the user.

30. The method according to claim 29, wherein said value comprises at least one of:
a value of prepaid long distance,
a value of communications services,
a value of minutes of services,
a monetary value,
an account value,
a checking account value,
a savings account value,
a money market account value,
a credit value,
a debit value, and/or
a quantity of products and/or services value.

31. The method according to claim 29, further comprising:
pre-provisioning an account associated with the communications device of the user a promotional amount of said value.

32. The method according to claim 29, further comprising:
prompting the user to replenish said value.

33. The method according to claim 29, wherein said use of said value comprises at least one of:
placing a telecommunications call,
purchasing a product and/or service,
accessing a service,
sending money,
purchasing a product and/or service appearing online,
purchasing a product and/or service appearing on a broadcast,
purchasing a product and/or appearing on programming,
purchasing a product and/or service appearing on broadcast programming,
purchasing a product and/or service appearing on a direct response television (DRTV) broadcast television, and/or
purchasing a product and/or service appearing on a Home Shopping Network (HSN) and/or QVC broadcast programming.

34. The method according to claim 29, further comprising:
providing a button on the communications device dedicated to accessing said value.

35. The method according to claim 29, further comprising:
pre-provisioning an account associated with the communications device of the user a promotional amount of said value.

36. The method according to claim 29, further comprising:
prompting the user to replenish said value.

37. The method according to claim 29, further comprising:
prompting the user to authorize use of said value.

38. The method according to claim 37, wherein said authorizing comprises at least one of:
prompting the user to provide at least one of a validation; entry of a password; entry of a personal identification number (PIN); a biometric; a reverse Turing test; and/or a digital signature.

39. The system according to claim 25, further comprising:
providing a button on the communications device dedicated to accessing value associated with a user,
wherein said value comprises at least one of:
a value of prepaid long distance,
a value of communications services,
a value of minutes of services,
a monetary value,
an account value,
a checking account value,
a savings account value,
a money market account value,
a credit value,
a debit value, and/or
a quantity of products and/or services value.
